(19) United States
(12) Patent Application Publication
(10) Pub. No.: US 2010/0303104 A1
(43) Pub. Date: Dec. 2, 2010

(54) Apparatus and Method for Removing Unwanted Optical Radiation from an Optical Fiber

(75) Inventors: Nicolas Bennetts, Fareham (GB); Kevin Patrick Sheehan, Eastleigh (GB); Fei Sun, Edinburgh (GB)

Correspondence Address: AXINN, VELTROP & HARKRIDER LLP;Attn. Michael A. Davitz, 114 West 47th Street, New York, NY, 10036, US

(73) Assignee: SPI LASERS UK LIMITED, Hedge End (GB)

(21) Appl. No.: 12/863,099

(22) PCT Filed: Jan. 19, 2009
(86) PCT No.: PCT/GB09/00134

§ 371 Date: Jul. 15, 2010

(30) Foreign Application Priority Data
Jan. 18, 2008 (GB) 0800976.3

(51) Int. Cl. H01S 3/30; G02B 6/26

(52) U.S. Cl. 372/6; 385/29

(57) ABSTRACT

Apparatus comprising a source of optical radiation (15), an optical fibre (1), and an absorbing material (2), wherein; the optical fibre (1) comprises a core (37), at least one cladding (38), and an optical surface (3); the source of optical radiation (15) provides optical radiation (16) that propagates along the core (37) of the optical fibre (1), and unwanted optical radiation (14) that propagates along the cladding (38) that surrounds the core (37); and the absorbing material (2) is in contact with the optical surface (3) over a length (5) of the optical fibre (1). The apparatus is characterized in that: the absorbing material (2) has a refractive index (101) that is higher than a refractive index (100) of the optical surface (3) within a temperature range (102) thus enabling the unwanted optical radiation (14) to pass from the optical fibre (1) into the absorbing material (2) within said temperature range (102); the absorbing material (2) is such that it can absorb at least some of the unwanted optical radiation (14) that enters into it from the optical fibre (1); the absorbing material (2) is such that its temperature increases upon absorption of the unwanted optical radiation (14); and the absorbing material (2) is such that its said refractive index (101) reduces with increasing temperature. This has the effect of limiting the amount of the unwanted optical radiation (14) that can be removed per unit length of optical fibre (1) to a predetermined absorption per unit length (62). Thus the apparatus is such that it is able to remove the unwanted optical radiation (14) up to a power level (12) substantially equal to the product of the predetermined absorption per unit length (62) and the length (5) over which the absorbing material (2) is in contact with the optical surface (3).

This invention relates to an apparatus and method for removing unwanted optical radiation from an optical fibre. The invention has application for manufacturing articles using lasers.

High power lasers are used for many applications including welding, cutting, brazing and drilling materials, as well as medical treatments and defence applications. A key requirement for high power lasers is the ability to strip optical power from the cladding of an optical fibre. This is particularly the case where optical power is launched into a fibre, for example at the input to an optical fibre beam delivery optical fibre cable, or at a splice between components in a fibre laser. Prior art cladding mode stripping techniques for removing unwanted high optical powers (>1 W) from optical fibres include surrounding the splice with a high temperature acrylate.

Prior art cladding mode strippers are either refractive index based (polymers, oils) for removing the waveguiding properties of the optical fibre, or absorption based (absorbing coatings, abrasion of the surface to scatter light). Abrasion or etching can lead to weakening of the fibre and resulting reliability failures in the field. Polymers tend to photodarken with the more power put into them, which increases absorption, and therefore absorbs more power in a shorter length. This can then lead to failure.

For high power cladding mode strippers (>1 W), the power stripped from the fibre heats the surrounding material, and the splice can fail. This is a major problem with high power lasers such as fibre lasers. Heating can cause failures during the manufacture of the product and also reliability issues with installed products. The amount of power that can be stripped in many of these schemes has an upper limit. For example it is difficult to strip more than 10 W using a polymer because polymers typically degrade at high temperatures.

For a fibre laser spool, the core absorbs pump light. Residual pump light remains in the cladding and propagates to the output splice. For a splice loss of 0.05 dB (from core to core), there is approximately 1% of power lost from the core into the cladding. Thus the total amount of power to be removed is the sum of the 1% of signal together with the residual pump power. For a 10 W laser, this can be 1 W, for a 100 W laser, this can be 2 W to 10 W, and for a 400 W laser, this can be 5 W to 40 W.

Similar problems occur in splicing the output of the fibre laser to fibre optic beam delivery cables. A 1% splice loss may not be too significant for a 10 W laser, but it is for lasers having output powers of 50 W or more.

Other disadvantages of prior art cladding mode stripping techniques is that the fibres need to be sealed from moisture, and they often use rigid packaging. There are constraints on the ends relating to fixing the fibres to the packages. Pull strength issues, thermal expansion mismatch issues, and the space taken to bend the fibres at either end have to be considered.

An aim of the present invention is to provide an apparatus and method for removing unwanted optical radiation from an optical fibre which reduces the above aforementioned problems.

According to a non-limiting embodiment of the present invention, there is provided apparatus comprising a source of optical radiation, an optical fibre, and an absorbing material, wherein: the optical fibre comprises a core, at least one cladding, and an optical surface; the source of optical radiation provides optical radiation that propagates along the core of the optical fibre, and unwanted optical radiation that propagates along the cladding that surrounds the core; and the absorbing material is in contact with the optical surface over a length of the optical fibre; the apparatus being characterized in that: the absorbing material has a refractive index that is higher than a refractive index of the optical surface within a temperature range thus enabling the unwanted optical radiation to pass from the optical fibre into the absorbing material within said temperature range; the absorbing material is such that it can absorb at least some of the unwanted optical radiation that enters into it from the optical fibre; the absorbing material is such that its temperature increases upon absorption of the unwanted optical radiation; and the absorbing material is such that its said refractive index reduces with increasing temperature thereby limiting the amount of the unwanted optical radiation that can be removed per unit length of optical fibre to a predetermined absorption per unit length; whereby the apparatus is such that it is able to remove the unwanted optical radiation up to a power level substantially equal to the product of the predetermined absorption per unit length and the length over which the absorbing material is in contact with the optical surface.

According to another non-limiting embodiment of the invention, there is provided a method comprising the steps of: providing an optical fibre comprising a core, at least one cladding, and an optical surface; providing a source of optical radiation; propagating the optical radiation along the core of the optical fibre, and unwanted optical radiation along the cladding that surrounds the core; providing an absorbing material characterized by a refractive index having a higher refractive index than the optical surface within a temperature range; placing the absorbing material in contact with the optical surface over a length of the optical fibre; the method being characterized in that it includes the following steps: using the refractive index difference between the absorbing material and the optical surface to remove the unwanted optical radiation from the fibre within said temperature range; absorbing at least some of the unwanted optical radiation that has been removed from the fibre by the absorbing material; increasing the temperature of the absorbing material with the unwanted optical radiation that is absorbed by the absorbing material; and reducing the refractive index of the absorbing material and thereby limiting the amount of the unwanted optical radiation that can be removed per unit length of optical fibre to a predetermined absorption per unit length; whereby the method can remove the unwanted optical radiation up to a power level substantially equal to the product of the predetermined absorption per unit length and the length over which the absorbing material is in contact with the optical surface.

The optical fibre may have a coating covering the optical surface, and wherein the coating is removed from the said length of the optical fibre to expose the optical surface.

The absorbing material may have a thermal conductivity in one plane that is different from a thermal conductivity in another plane. The absorbing material may comprise graphite, pyrolytic carbon, metals, carbon matrix composites, metal matrix graphite composites, metal alloys such as AlSiC, CuW, CuMo and high thermal conductivity ceramics.

The absorbing material may be in the form of at least one sheet. The optical fibre may be sandwiched between a plurality of the sheets.

The absorbing material may include an adhesive. The adhesive may be a high temperature polymer, an acrylate, a gel, or an oil.

The pre-determined absorption per unit length may be greater than about 0.5 W/mm. The pre-determined absorption per unit length may be greater than about 1 W/mm.

Temperature control means may be provided for maintaining the absorbing material in close proximity to the optical fibre at a temperature below which the said power level is reached. The temperature control means may comprise a heat sink, and wherein the absorbing material is in thermal contact with the heat sink. The temperature control means may comprise a cold plate, and wherein the absorbing material is in thermal contact with the cold plate.

The absorbing material may be non-planar. Alternatively or additionally, the optical fibre may be curved within the absorbing material.

The invention may be a laser comprising one of the aforementioned apparatus. The laser may have an output power greater than about 50 W. The optical fibre may form part of a beam delivery cable.

Embodiments of the invention will now be described solely by way of example and with reference to the accompanying drawings in which:

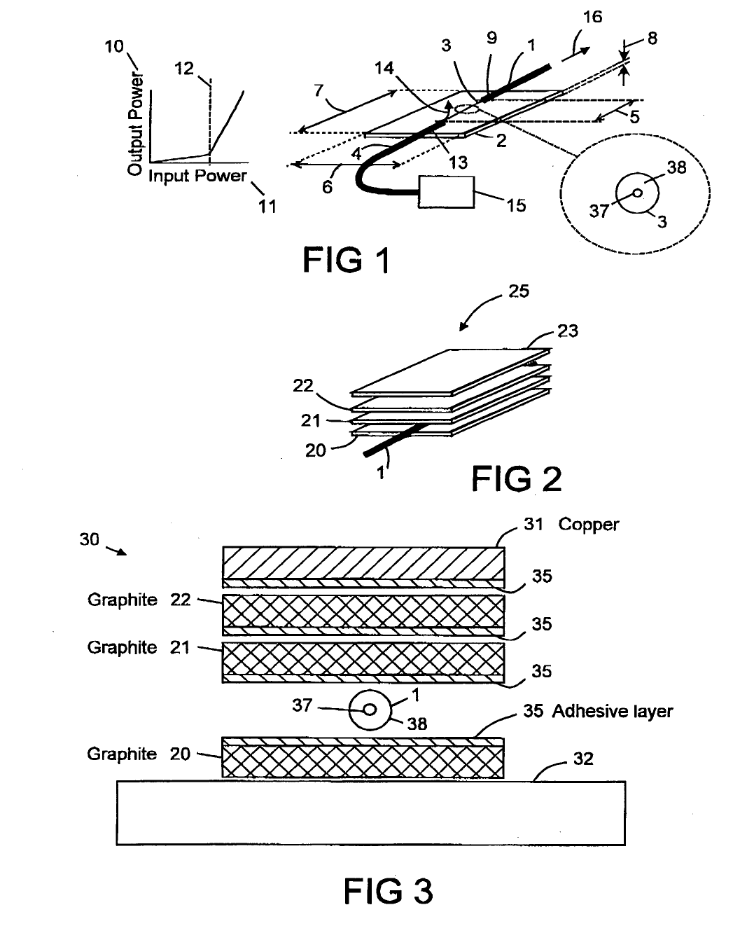

FIG. 1 shows an apparatus for removing unwanted optical radiation from an optical fibre according to the present invention;

FIG. 2 shows a preferred embodiment of the invention in which an optical fibre is sandwiched between sheets of an absorbing material;

FIG. 3 shows a cross-section of an apparatus in which the absorbing material comprises graphite;

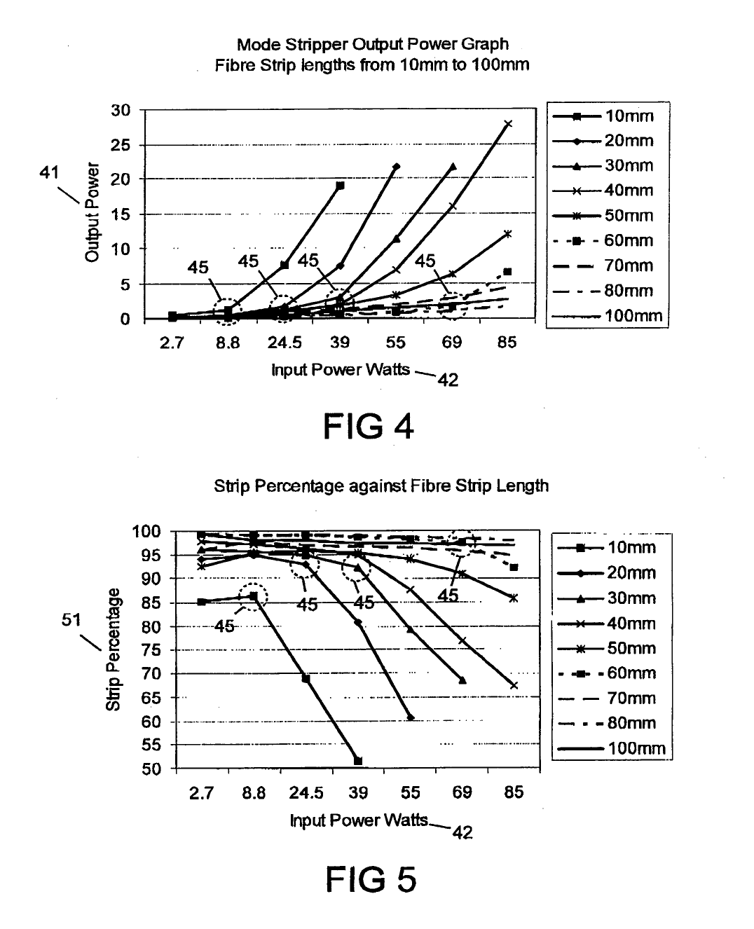

FIG. 4 shows the output power measured in an apparatus according to the present invention;

FIG. 5 shows the strip percentage for different strip fibre lengths measured in an apparatus according to the present invention;

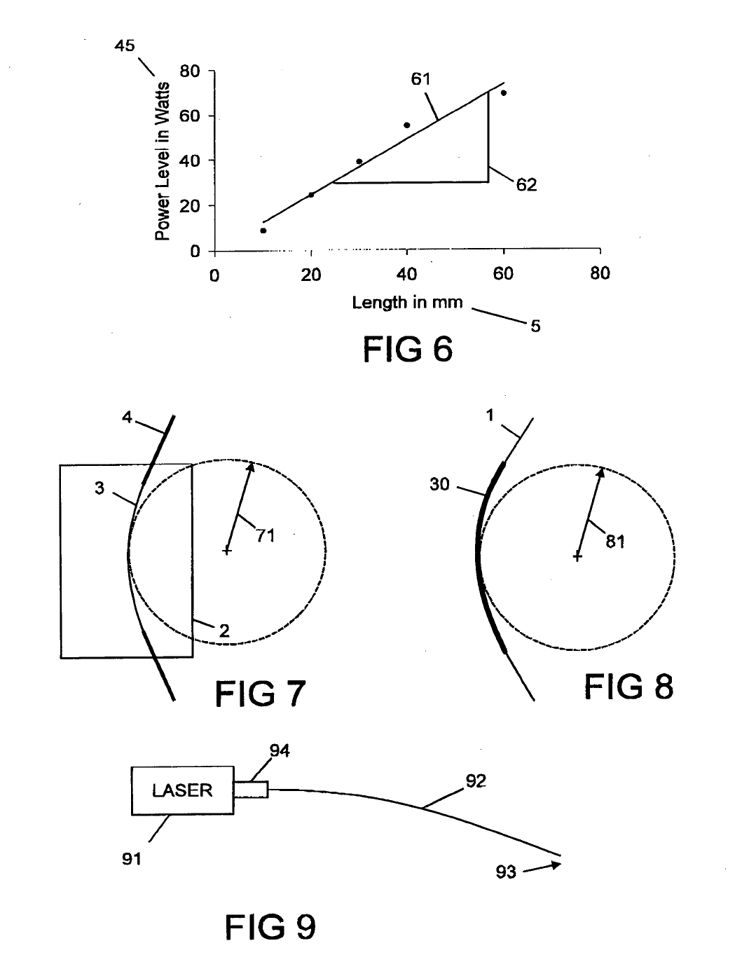

FIG. 6 shows the said power level measured as a function of stripped fibre length;

FIG. 7 shows an apparatus in which the fibre is curved;

FIG. 8 shows an apparatus which is curved;

FIG. 9 shows a laser including a beam delivery cable; and

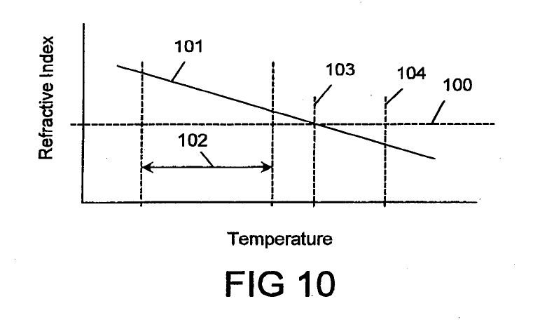

FIG. 10 shows the refractive index variation with temperature of the absorbing material.

Referring to FIG. 1, there is shown apparatus comprising a source of optical radiation 15, an optical fibre 1, and an absorbing material 2, wherein: the optical fibre 1 comprises a core 37, at least one cladding 38, and an optical surface 3; the source of optical radiation 15 provides optical radiation 16 that propagates along the core 37 of the optical fibre 1, and unwanted optical radiation 14 that propagates along the cladding 38 that surrounds the core 37; and the absorbing material 2 is in contact with the optical surface 3 over a length 5 of the optical fibre 1. The apparatus is characterized in that: the absorbing material 2 has a refractive index 101 (shown with reference to FIG. 10) that is higher than a refractive index 100 of the optical surface 3 within a temperature range 102 thus enabling the unwanted optical radiation 14 to pass from the optical fibre 1 into the absorbing material 2 within said temperature range 102; the absorbing material 2 is such that it can absorb at least some of the unwanted optical radiation 14 that enters into it from the optical fibre 1; the absorbing material 2 is such that its temperature increases upon absorption of the unwanted optical radiation 14; and the absorbing material 2 is such that its said refractive index 101 reduces with increasing temperature. As is shown with respect to FIG. 6, this has the effect of limiting the amount of the unwanted optical radiation 14 that can be removed per unit length of optical fibre 1 to a predetermined absorption per unit length 62. Thus the apparatus is such that it is able to remove the unwanted optical radiation 14 up to a power level 12 substantially equal to the product of the predetermined absorption per unit length 62 and the length 5 over which the absorbing material 2 is in contact with the optical surface 3.

The refractive index 100 of the cladding 38 at the optical surface 3, the refractive index 101 of the absorbing material 2, and the temperature range 102 are shown with reference to FIG. 10. Also shown is a temperature 103 at which the refractive index 101 of the absorbing material 2 is equal to the refractive index 100, and a temperature 104 at which the refractive index 104 is lower than the refractive index 100.

The thermally-limiting power limitation provided by the apparatus of FIG. 1 is depicted in a graph of an output power 10 versus an input power 11. The input power 11 is the amount of the unwanted optical radiation 14 propagating in the optical fibre 1 propagating at or near to an input location 13 where the optical surface 3 comes into contact with the absorbing material 2, and the output power 10 is the amount of unwanted optical radiation 14 propagating in the optical fibre 1 at or near an output location 9 where the optical surface 3 becomes no longer in contact with the absorbing material 2. The output power 10 increases substantially more rapidly with respect to the input power 11 when the input power 11 is higher than the power level 12 than when the input power 11 is less than the power level 12.

The optical fibre 1 is shown having a coating 4, which has been removed to expose the optical surface 3 within the length 5. The optical surface 3 may be the glass surface of the optical fibre 1 within which the unwanted optical radiation 14 is propagating. In certain optical fibres, the optical surface 3 could be the outer surface of a polymer cladding within which the unwanted optical radiation 14 is propagating. The absorbing material 2 is shown having dimensions comprising a width 6, a length 7, and a thickness 8.

FIG. 2 shows a preferred embodiment of an apparatus 25, in which the absorbing material 2 comprises a graphite sheet 20. The apparatus 25 is in the form of a cladding mode stripper for removing the unwanted optical radiation 14 propagating in the cladding 38. The fibre 1 has been placed onto the graphite sheet 20, and then two additional graphite sheets 21, 22 placed on top of the fibre 1. The graphite sheets 20, 21 and 22 collectively comprise the absorbing material, and may be of the same design as each other, or at least one of the graphite sheets 20, 21 or 22 may be of a different design. Optionally, an additional sheet 23 may be added to assist packaging and improve thermal dissipation. Improving thermal dissipation can increase the pre-determined absorption per unit length 62 and the power level 12, and thus extend the power rating and reliability of the apparatus 25. The additional sheet 23 may be a metal foil.

A cross-section (not to scale and parts separated for clarity) of an apparatus 30 is shown in FIG. 3. The fibre 1 is shown as having the core 37 through which desired optical radiation 16 would propagate and the cladding 38 through which the unwanted optical radiation 14 would propagate. The unwanted optical radiation 14 is the power that is propagating in the cladding 38, and this is the power that is removed from the fibre 1 by the apparatus 30. The cladding 38 is typically surrounded by the coating 4. A metal film 31 has been attached to the graphite sheet 22, and the graphite sheet 20 has been attached to a temperature control means 32. The temperature control means 32 preferably maintains the absorbing material in close proximity to the optical fibre at a temperature below which the said power level 12 is reached. The temperature control means 32 can be a cold plate or a heat sink. The metal film 31 can be copper (as shown), aluminum, or a metal foil. The metal film 31 improves robustness and aids heat dissipation. Preferably, the graphite sheets 20 to 22 and the metal film 31 can include adhesive 35 which can be used to bind the apparatus 30 together. The adhesive 35 can be an acrylate such as a high temperature acrylate. The adhesive 35 can also comprise or be a polymer such as a high temperature polymer, a gel, or an oil. The cross-section shown in FIG. 3 has been drawn with the various components separated for clarity. These components would in practice be assembled together. In an experiment, the temperature control means 32 was a cold plate, and it was found preferable to press the apparatus 30 against the cold plate by a clamp (not shown) with a clamping force of around 2 to 5 kg/cm².

By film, strip, foil or sheet, it is meant a foil, sheet, strip, tape or a layer of material that is thin in comparison with its lateral dimensions.

Surprisingly, the apparatus 30 has a much higher efficiency than prior art cladding mode strippers. In addition, the apparatus 30 has more efficiency than was achieved by simply placing the optical fibre 1 onto a metal surface such as copper. Efficiencies greater than 99% have been achieved over a 5 mm length 5.

FIG. 4 shows the measured output power 41 versus input power 42 of the apparatus 30. The different curves correspond to different lengths of the length 5, the actual lengths being shown in the legend. As the input power 42 is increased, the output power 41 increases. Surprisingly, each of the curves show a power 45 above which the apparatus 30 reaches some form of saturation. The saturation is seen as the output power 41 increasing substantially more rapidly with respect to the input power 42 when the input power 42 exceeds the power 45 than when the input power 42 is less than the power 45. The power 45 increases with increasing length 5. The longer the length 5 in which the optical surface 3 of the optical fibre 1 is in contact with the absorbing material 2, the higher the power 45. Thus the output power 41, the input power 42, and the power 45 correspond to the output power 10, the input power 11 and the power level 12 of FIG. 1.

FIG. 5 shows the data of FIG. 4 plotted as strip percentage 51 versus the input power 42 for different stripped fibre lengths 5. By strip percentage 51, it is meant the ratio of the power not removed from the fibre 1 to the power removed from the fibre 1. Note that this power does not include the desired optical radiation 16 that propagates through the core 37 (if present) of the fibre 1. In an ideal cladding mode stripper, all the power not propagating through the core 37 of the fibre 1 would be stripped from the fibre 1, and thus the strip percentage 51 (or efficiency) would be 100%. The power 45 is seen as an input power 42 beyond which the strip percentage 51 reduces rapidly.

FIG. 6 shows a plot of the power 45 versus the fibre length 5. The data were obtained from FIG. 4. Surprisingly, the dependence of the power 45 (at which the output power 41 increases more rapidly with respect to the input power 42) versus the fibre length 5 is approximately linear. The gradient defines the predetermined absorption per unit length 62. The apparatus 30 is effective as long as the input power 42 required to be stripped (or removed from the fibre 1) does not exceed the product of the length 5 and the predetermined absorption per unit length 62. In the experiment, the predetermined absorption per unit length 62 was approximately 1 W/mm of stripped fibre length 5 (shown with reference to FIG. 1) for a 125 μm diameter fibre. The approximately linear dependence of the power 45 with length 5 is advantageous because it means that each part of the apparatus 30 saturates in turn along the length 5. If this were not so, then the first part of the apparatus 30 would remove more and more power, absorb more and more power, and its temperature would rise higher and higher. The device would then eventually fail owing to thermal dissipation problems. Instead, this does not happen, allowing cladding mode strippers that can strip increased power levels 45 by simply increasing the length 5 of the apparatus 30 without suffering excessive temperature rises.

The graphite sheets 20, 21, 22 shown in FIG. 3 corresponding to the data of FIGS. 4, 5 and 6 were manufactured by GrafTech International of Ohio, USA. The thickness 8 was 0.005 inches (approximately 125 μm), the thermal conductivity was 400 W/m/K in plane, and 20 W/m/K out of plane. The copper tape 31 was 76 μm thick and had a thermal conductivity of approximately 420 W/m/K. The graphite sheets 21, 22, 23 had an adhesive layer 35 of between approximately 75 μm to 125 μm thick.

### EXAMPLE

In order to strip 80 W of power with a predetermined absorption per unit length 62 of 1 W/mm with the apparatus of FIG. 3, a stripped length 5 of approximately 80 mm was required, this being equal to 80 W divided by 1 W/mm. It was found convenient to oversize the length 7 of the sheets 20 to 23 by 15 mm on each end in order to anchor the fibre 1 to the sheets 20, 21. The width W of the sheets 20 to 23 was varied experimentally. A convenient width W was found to be 35 mm, which gave good absorption without making the device too large. Thus the apparatus 30 had an overall size of 110 mm×35 mm, with a thickness of approximately 0.5 mm to 1 mm, and was pressed against the cold plate 32 with a clamping force of approximately 3 kg/cm².

Although the example was for an apparatus 30 having a predetermined absorption per unit length 62 of approximately 1 W/mm, the materials and dimensions of the sheets 20 to 23 can be selected to provide different values of the predetermined absorption per unit length 62. For example, reducing the width 6 of the sheets can reduce the predetermined absorption per unit length 62. Preferably, the dimensions (width 6 and thickness 8) and materials of the apparatus 30 should be selected to give a predetermined absorption per unit length 62 of at least 0.5 W/mm, and preferably at least 1 W/mm, the exact figure being dependent upon the thermal degradation properties of the materials, and in particular the adhesive 35.

The cladding mode stripping performance of the apparatus shown in FIGS. 1 to 3 was investigated using between one and three sheets of graphite, and with or without the adhesive 35 being present. It was found that the apparatus perform best if the graphite sheet 21 includes the adhesive 35 and that increased efficiency (that is strip percentage 51) is obtained with two, or better still, three sheets of graphite. This may be because two sheets provide greater lateral heat dissipation than a single sheet. It may also indicate that better efficiency could have been obtained by increasing the thickness 8. Additionally, the graphite sheet 20 should be kept in contact with the cold plate 32.

The underlying physics behind the invention is not fully understood. Without intending to limit the invention in any way, it is currently believed that the graphite sheet 20 that is in contact with the optical surface 3 of the optical fibre 1 has a real refractive index that is greater than the refractive index of silica. Thus placing the fibre 1 in contact with the graphite sheet 20 will lead to a loss of guidance at the glass/graphite sheet surface. Light is thus lost into the graphite sheet 20, whereupon the imaginary refractive index leads to a high levels of absorption. The absorbed power heats the graphite sheet 20. The limiting power level 45 is believed to occur because the heat changes the real and imaginary refractive indices of the graphite sheet 20, which affects the amount of power coupling from the fibre 1 into the graphite sheet 20. It is believed that it is the refractive index of the adhesive layers 35 of the graphite sheets 20 and 21 that are pressed against the fibre 1 that are mainly responsible for the removal of light from the fibre 1, the graphite material of the graphite sheets 20 and 21 are mainly responsible for the absorption of the light and the consequent heating of the adhesive 35 that contacts the glass surface 3. Additionally, the graphite advantageously conducts heat laterally away from the fibre 1. Hence further optimization should be possible by using different polymers, gels, adhesives and oils, either alone or in combination, as the material comprising the adhesive 35 that is in contact with the fibre 1. Preferably the adhesive 35 should surround the optical fibre 1 in order to maximize the removal of the unwanted optical radiation 14 and thus increase the power level 45 at which the device saturates. Additionally, bending the fibre 1 can be used to increase the amount of light coupled out. The fibre 1 can be non-planar. The fibre 1 can be bent with a radius of curvature 71 within the plane of the apparatus as shown with reference to FIG. 7. Alternatively or additionally, the absorbing material 2 can be non-planar. For example, the apparatus 30 can be bent with a radius of curvature 81 as shown with reference to FIG. 8. The radii of curvature 71 and 81 are preferably less than 1 m, and more preferably between 10 mm and 100 mm.

Similar devices have been made in which the graphite sheets 20, 21, 22 have been replaced with metal foil such as aluminum or copper. The devices display a similar behaviour, exhibiting power levels 45 above which the amount of unwanted optical radiation 14 removed from the optical fibre 1 saturates. However, the power levels 45 at which saturation occurs is very much lower than with the apparatus 30 of FIG. 3. In addition, these did not provide the greater than approximately 95% efficiency 51 as was demonstrated using the graphite sheets 20, 21, 22.

Properties of graphite which makes it ideal in this application include the fact that graphite is extremely difficult to burn, has a very high thermal conductivity particularly in the plane of the sheet, and is flexible.

The high thermal conductivity in plane means that heat dissipates laterally from the fibre 1 very efficiently. This leads to a more reliable package because heat is transmitted laterally away from the fibre 1. Hot spots near the fibre 1 are thus avoided, which removes a failure mechanism observed in high power lasers.

The flexibility of the graphite sheets 20, 21, 22 assists greatly in packaging since the fibres 1 are not contained in rigid packages and can be positioned with great ease, for example, within a laser. For example, the apparatus 30 can be built upon a flat surface such as a cold plate, or a curved surface such as a coil former. It is also relatively simple to build the apparatus 30 such that it can be bent with, or is constructed with, a radius of curvature of 1 m or less. Radii of curvature less than 10 mm can be achieved.

Preferably, the temperature of the graphite sheet 20 in contact with the fibre 1 should be less than a temperature (not shown) corresponding to the power 45 shown in FIGS. 4 and 5. This can be achieved by attaching or assembling the cladding mode stripper on a heat sink or cold plate. This is because increasing the temperature of the graphite sheet 20 in contact with the fibre 1 has the effect of reducing the efficiency of the apparatus 30.

The apparatus 30 has been proven over long term test trials in which a fibre laser comprising the apparatus 30 has undergone environmental testing appropriate for the industrial laser market. The invention thus extends to lasers such as the laser 91 shown with reference to FIG. 9 that comprise the apparatus described with reference to FIGS. 1 to 8. The laser 91 is shown with a fibre optic beam delivery cable 92 comprising an optical fibre (not shown) which transmits the laser radiation emitted by the laser 91 to a remote location 93. The remote location 93 can be a laser processing tool head for welding, cutting, brazing, drilling or processing industrial materials. The laser 91 can be a fibre laser, a disk laser, or a rod laser. The invention is particularly useful for splicing optical fibres carrying high power (>50 W) laser radiation. This is because it is important to remove optical power lost from the core 37 of the optical fibre 1 at the splice, and the usefulness increases the higher the power of the laser 91. Thus it is very advantageous with lasers such as fibre lasers having output powers in the region 100 W to 400 W. It is also very advantageous for very high power fibre lasers having output powers in the range 400 W to 10 kW or more.

Other materials which may be substituted for graphite would include materials having high thermal conductivity (>50 W/m/K) and high absorption. Suitable materials include pyrolytic carbon, metals, carbon matrix composites, metal matrix graphite composites, metal alloys such as AlSiC, CuW, CuMo and high thermal conductivity ceramics.

It is to be appreciated that the embodiments of the invention described above with reference to the accompanying drawings have been given by way of example only and that modifications and additional components may be provided to enhance performance.

1. An apparatus comprising a source of optical radiation, an optical fiber, and an absorbing material, wherein:
a) the optical fiber comprises a core, at least one cladding, and an optical surface;
b) the source of optical radiation provides optical radiation that propagates along the core of the optical fiber, and unwanted optical radiation that propagates along the cladding that surrounds the core; and
c) the absorbing material is in contact with the optical surface over a length of the optical fiber and the apparatus is characterized in that:
i) the absorbing material has a refractive index that is higher than a refractive index of the optical surface within a temperature range;
ii) the absorbing material is such that it can absorb at least some of the unwanted optical radiation that enters into it from the optical fiber;
iii) the absorbing material is such that its temperature increases upon absorption of the unwanted optical radiation; and
iv) the absorbing material is such that its said refractive index reduces with increasing temperature.

2. The apparatus according to claim 1, wherein the optical fiber has a coating covering the optical surface, and wherein the coating is removed from the said length of the optical fiber to expose the optical surface.

3. The apparatus according to claim 1, wherein the absorbing material has a thermal conductivity in one plane that is different from a thermal conductivity in another plane.

4. The apparatus according to claim 1, wherein the absorbing material comprises graphite.

5. The apparatus according to claim 1, wherein the absorbing material is in the form of at least one sheet.

6. The apparatus according to claim 1, wherein the optical fiber is sandwiched between a plurality of the sheets.

7. The apparatus according to claim 1, wherein the absorbing material includes an adhesive.

8. The apparatus according to claim 7, wherein the adhesive is a high temperature polymer, an acrylate, a gel, or an oil.

9. The apparatus according to claim 1, wherein the pre-determined absorption per unit length is greater than about 0.5 W/mm.

10. The apparatus according to claim 1, wherein the pre-determined absorption per unit length is greater than about 1 W/mm.

11. The apparatus according to claim 1, wherein the apparatus comprises a temperature control means for maintaining the absorbing material in close proximity to the optical fiber at a temperature below which the said power level is reached.

12. The apparatus according to claim 11, wherein the temperature control means comprises a heat sink, and wherein the absorbing material is in thermal contact with the heat sink.

13. The apparatus according to claim 11, wherein the temperature control means comprises a cold plate, and wherein the absorbing material is in thermal contact with the cold plate.

14. The apparatus according to claim 1, wherein the absorbing material is non-planar.

15. The apparatus according to claim 1, wherein the optical fiber is curved within the absorbing material.

16. The apparatus according to claim 1, wherein the apparatus comprises a laser.

17. The apparatus according to claim 16, wherein the laser has an output power greater than about 50 W.

18. The apparatus according to claim 16, wherein the optical fiber forms part of a beam delivery cable.

19. A method comprising the steps of:
a) providing an optical fiber comprising a core, at least one cladding, and an optical surface;
b) providing a source of optical radiation;
c) propagating the optical radiation along the core of the optical fiber, and unwanted optical radiation along the cladding that surrounds the core;
d) providing an absorbing material characterized by a refractive index having a higher refractive index than the optical surface within a temperature range;
e) placing the absorbing material in contact with the optical surface over a length of the optical fiber; and
f) using the refractive index difference between the absorbing material and the optical surface to remove the unwanted optical radiation from the fiber within said temperature range.

20) The apparatus according to claim 1, wherein the apparatus is able to remove the unwanted optical radiation up to a power level substantially equal to the product of the predetermined absorption per unit length and the length over which the absorbing material is in contact with the optical surface.

21) The apparatus according to claim 17, wherein the optical fiber forms part of a beam delivery cable.
